(19) United States
(12) Patent Application Publication
(10) Pub. No.: US 2013/0205144 A1
(43) Pub. Date: Aug. 8, 2013

(54) LIMITATION OF LEAKAGE POWER VIA DYNAMIC ENABLEMENT OF EXECUTION UNITS TO ACCOMMODATE VARYING PERFORMANCE DEMANDS

(71) Applicant: Jeffrey R. Eastlack, Austin, TX (US)

(72) Inventor: Jeffrey R. Eastlack, Austin, TX (US)

(21) Appl. No.: 13/760,691

(22) Filed: Feb. 6, 2013

Related U.S. Application Data
(60) Provisional application No. 61/595,148, filed on Feb. 6, 2012.

(51) Int. Cl. G06F 1/32

(52) U.S. Cl. CPC G06F 1/3293
USPC 713/320

(57) ABSTRACT

In an embodiment, a method of controlling performance of a processor having a first execution unit and a second execution unit includes maintaining an operational state of the first execution unit of the processor at active, monitoring a utilization of the processor, and based on the utilization, determining whether to alter the operational state of the second execution unit of the processor. When the utilization of the processor is below a first threshold and the performance capability of the second execution unit is less than the performance capability of the first execution unit, the system may change the operational state of the second execution unit of the processor to active, and the operational state of the first execution unit to inactive. When the utilization of the processor is above a second threshold, the system may change the operational state of the second execution unit of the processor to active.

### CROSS REFERENCE TO RELATED APPLICATION

This application claims the benefit of U.S. Provisional Application No. 61/595,148, filed on Feb. 6, 2012, which is hereby incorporated by reference in its entirety.

### BACKGROUND

Static power dissipation is quickly becoming the main component to the overall power consumption of the modern microprocessor or integrated circuit (IC). As we reduce horizontal feature size of the transistors we also reduce the vertical feature size. Transistors are built by the vertical layering of electrically dissimilar materials with extremely low and precise geometrical tolerances at the atomic scale. Some of the vertical slices are significantly thinner than the horizontal features. The gate oxide layer which separates charge between the gate from the p and n channels of the substrate can be measured by counting atoms of thickness. As this vertical scaling continues beyond 32 nm, the electric polarization field will continue to weaken and thus the gate oxide loses the ability to separate charge. Because of this, electrons have a less restricted flow. This results in increased static power or “leakage power,” which is now becoming the dominant power loss as process technology continues to scale. Functional units (FUs) within a pipeline's execution stages account for a large percentage of the microprocessors “on chip” real-estate. The amount of leakage within a given process technology is largely proportional to the number of transistors on the die. As static leakage power dissipation continues to worsen as CMOS scaling continues, technologies that reduce or eliminate leakage power dissipation will be of paramount importance. Dynamic power is a power component that is mainly a function of the applied voltage to the transistors and the frequency at which the clock is running which causes the logic to change state. If the voltage is higher and the clock is running faster, then the dynamic power associated with the IC will be much higher as the relationship between voltage/frequency versus power is non-linear.

In the mobile computing realm, many different techniques to conserve battery power exist including a technique called dynamic voltage frequency scaling (DVFS) which may use an operating system driver that monitors the systems utilization levels and will lower the voltage and frequency back to a run point that has been pre-determined to be stable. For example a mobile processor may be able to run at a maximum frequency of 1 GHz but the core voltage may need to be at 1.2V. During a lower performance demand or inactivity of the system, a voltage frequency controller may dynamically change the clock rate of the processor to 700 MHz or 400 MHz which may allow the voltage to be lowered to 1.0V or 0.8V respectively. The problem with this scenario is that the transistors are dissipating more leakage power at these lower frequency/voltage points than at the higher frequency/voltage points. This is because the voltage difference between the power rail and the gate of the transistor is lower which further reduces the transistors ability to separate charge and thus leakage is worse during these lower voltage and frequency operating points.

### PRIOR ART

“Dynamic Core Swapping,” U.S. Pat. No. 7,461,275 is similar to the approach of ARM Holding's “Big/Little implementation.” The method involves swapping out entire cores of different performance classes when performance demand changes.

“Power gating for multimedia processing power management,” U.S. Pat. No. 7,868,479, relates to a power management implementation designed to save power while driving a multimedia display.

“Power gating various number of resources based on utilization levels,” U.S. Pat. No. 7,868,479, involves the use of programmable logic devices (PLD) such as a FPGA. The technology statically power gates unused general purpose logic blocks within a programmable logic device during the programming phase

“Systems and methods for mutually exclusive activation of microprocessor resources to control maximum power,” U.S. Pat. No. 7,447,923, involves monitoring the maximum power threshold to invoke or power gate resources if the maximum power is below or above the specified threshold respectively.

“Dynamic leakage control circuit,” U.S. Pat. No. 7,266,707, involves power gating stages within a pipeline.

“Predictive Power Gating with Optional Guard Mechanism,” U.S. Pat. No. 8,219,834, involves using an algorithm to predict units to power gate.

### SUMMARY

### Field of Invention

In various embodiments, this invention relates to power gating technology within a microprocessor's pipeline stages. In some embodiments, when a high performing functional unit, such as, but not limited to, a pipelined floating point multiplier or divider is operating at a reduced voltage and frequency point it will be disabled via power gating and during which time a medium or lower performing functional unit with a lower leakage signature will be enabled to take its place.

In some embodiments, the method swaps functional units within the core which allows finer grained performance scaling with the huge benefit of preserving the die space associated with the other processor logic within the processor core without duplicate copies of said logic.

In some embodiments, power gating is determined via decode logic without the need to predict. Some embodiments involve power gating functional units within an execution stage of a processor pipeline, rather than power gating entire stages of the processor pipeline.

A modern high-end microprocessor may have more than a dozen functional units within the execution stages of its pipeline. This plurality of functional units is included to provide an increase in instruction level parallelism during the execution of a program in order to increase the instruction execution throughput. However, depending on the application, many of these functional units may remain in the idle state, in which they incur static leakage power dissipation which reduces battery life and could limit reliability. For example a cell phone may be on standby mode while playing an audio file, which is a case where a coarse grained level of power gating cannot be applied. In this case the microprocessor may need to be running, but not at max frequency due to the lower performance needs of the application.

The invention described in this disclosure expands the existing concept of dynamic voltage frequency scaling to enable the mutually exclusive power gating of higher performing execution units 208 versus medium and lower performing execution units 702 and 118 in parallel to the switching between voltage/frequency points such as 602, 604 and 606.

The result of switching to one or more lower performing execution units during the period of lower voltage/frequency operation may be that fewer transistors will be powered up and leaking, as FUs that operate at lower clock frequencies do not require as many stages in the pipeline or the associated pipeline registers. In addition, since the timing constraints are lowered, the width versus length (W/L) ratio of the transistor channel may be lower since the timing issues associated with parasitic capacitance of the circuit will have less of an effect at lower frequency. This will allow the processor implementation to dramatically reduce the number of leaking transistors during low voltage/frequency operation while lowering their amount of static power at the same time. In addition, it is also possible to implement the medium or lower performing execution units on a lower performing process technology that is tuned for power reduction, as most modern implementation have performance versus power tuned process technologies that are realized on the same die.

In short, implementing the concepts disclosed in this invention disclosure may significantly reduce static leakage power by some of the following: 1) reducing the number of transistors that are leaking during the lower voltage/frequency operating point such as 602, 604, and 606 by using execution units that require less transistors. 2) reducing the physical size of each transistor as the timing constraints at lower voltage/frequency operating points are less demanding. 3) permitting lower performing execution units to be implemented on a process technology that has been tuned for power.

It is important to note that the invention concept of swapping execution units described in this invention disclosure may also be implemented without the use of dynamic voltage frequency scaling to reduce power consumption as shown algorithmically in FIG. 8.

### BRIEF DESCRIPTION OF THE DRAWINGS

FIG. 1 shows a diagram of the classic five stage pipeline within a microprocessor, with the execution stages 3-27 employing the use of lower performing non-pipelined FUs, according to an embodiment.

FIG. 2 shows a diagram of the classic five stage pipeline within a microprocessor, with the execution stages 3-27 employing the use of higher performing pipelined FUs, according to an embodiment.

FIG. 3 shows a block diagram of the classic five stage pipeline within a microprocessor, with the execution stages 3-27 employing the use of lower, medium and higher performing execution units as potential candidates for instruction issue, according to an embodiment.

FIG. 4 shows a block level description of the control units needed to enabled or disable the higher, medium, or lower performing execution units, according to an embodiment.

FIG. 5 shows a possible control algorithm that may be used to enable and disable the higher, medium, and lower performing execution units, according to an embodiment.

FIG. 6 shows the possible voltage and frequency points that may be enabled to run the higher, medium, and lower performing execution units, according to an embodiment.

FIG. 7 shows a possible mix of higher and lower performing functional units within an execution unit to allow increased scalability, according to an embodiment.

FIG. 8 shows a possible control algorithm of an implementation that performs the execution unit swapping without changing voltage and frequency operating points, according to an embodiment.

FIG. 9 illustrates a system having an auxiliary execution unit, according to an embodiment.

FIGS. 10 and 11 illustrate process flows for controlling performance of a processor, according to various embodiments.

FIG. 12 is an exemplary computer system that may be operated as part of the system and/or method, according to an embodiment.

### DETAILED DESCRIPTION

The dynamic scaling of voltage and frequency is a popular method to reduce dynamic power of a microprocessor during periods of reduced demand. This invention disclosure expands on the concept where an execution unit 118 with lower performing FUs 106, 108, 110, and 112 may be enabled during a lower voltage/frequency point such as 602 where then an execution unit such as 702 and 208 with higher performing FUs may be power gated.

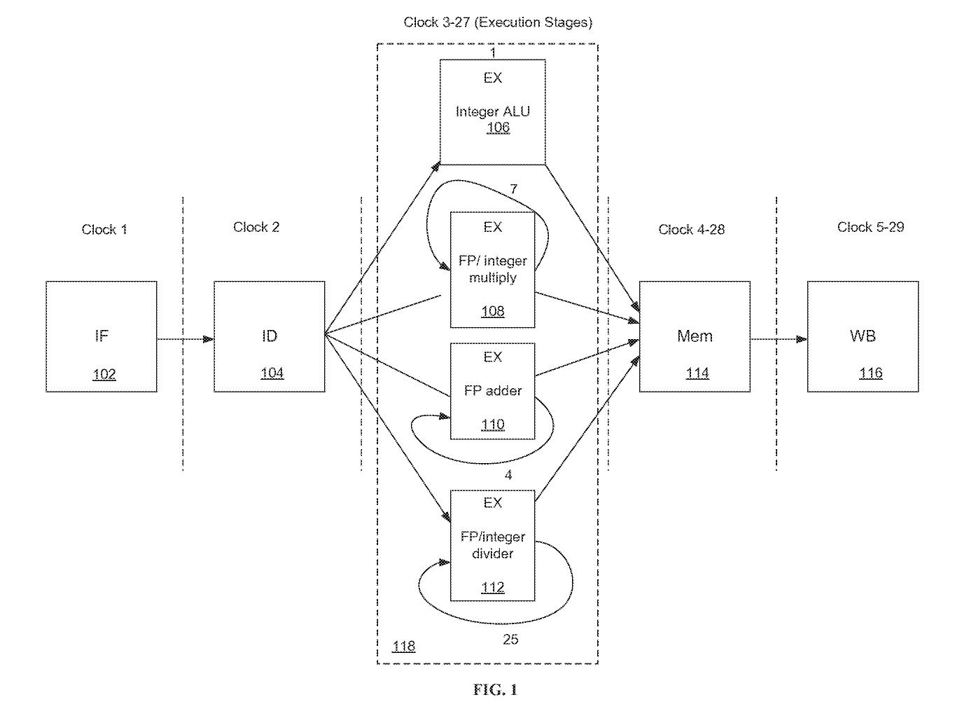

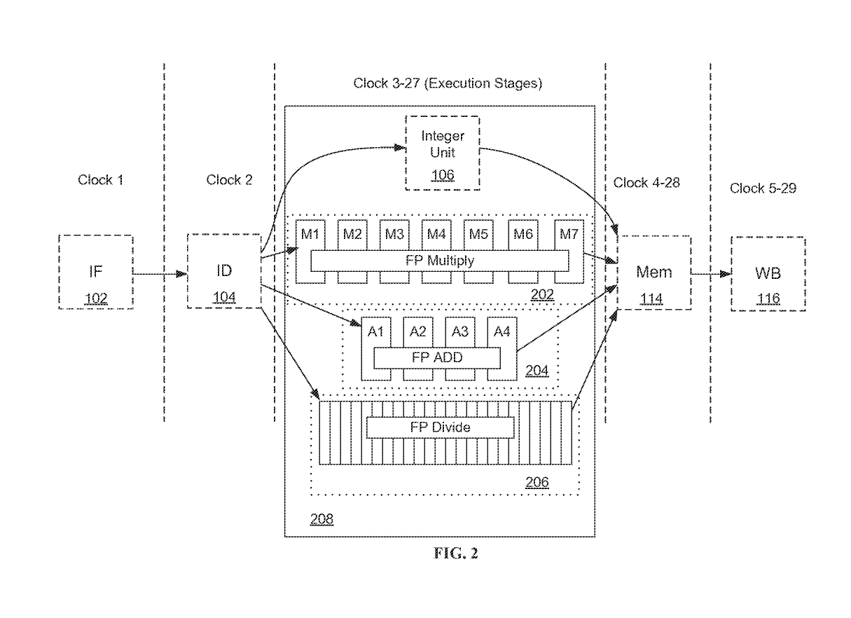

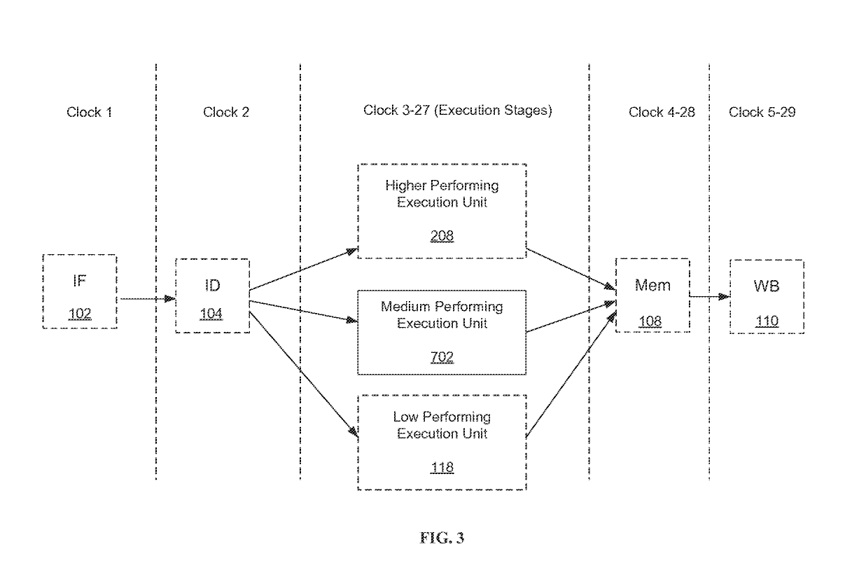

The concept of pipelining was introduced commercially around the 1980's as a way to exploit instruction level parallelism with the execution of a sequential program. Operations to be performed on the instructions are broken down into stages that occur in succession. The instructions enter the pipeline in an assembly line fashion to effectively increase the throughput of completed instructions. FIG. 1 shows a classic five stage pipeline. The first stage of the pipeline is the instruction fetch (IF) stage 102, which among other things the current instruction is fetched from memory. Then second stage is the instructions decode (ID) stage 104 where decoding is done in parallel to register reads. The third section of stages is the execution stages (EX) 118, which have been expanded to include FUs that perform multi-cycle operations. The execution stages of the pipeline are the main focus of this invention disclosure. The fourth stage is a memory access 108 stage which applies to loads and stores and finally the write back stage 110 to registers.

With the an implementation that uses Dynamic Voltage Frequency Scaling (DVFS) a microprocessor may be operating at a higher voltage/frequency point such as 606 where a higher level of performance is required during a period of high utilization. However, during periods of low utilization the processor may operate at a lower frequency, which in turn allows it to run at a reduce voltage level since the signal timing constraints have been somewhat relieved. A lower voltage and frequency reduces dynamic power, but a reduced voltage may increase leakage if the voltage potential difference between the gate and the supply is too low.

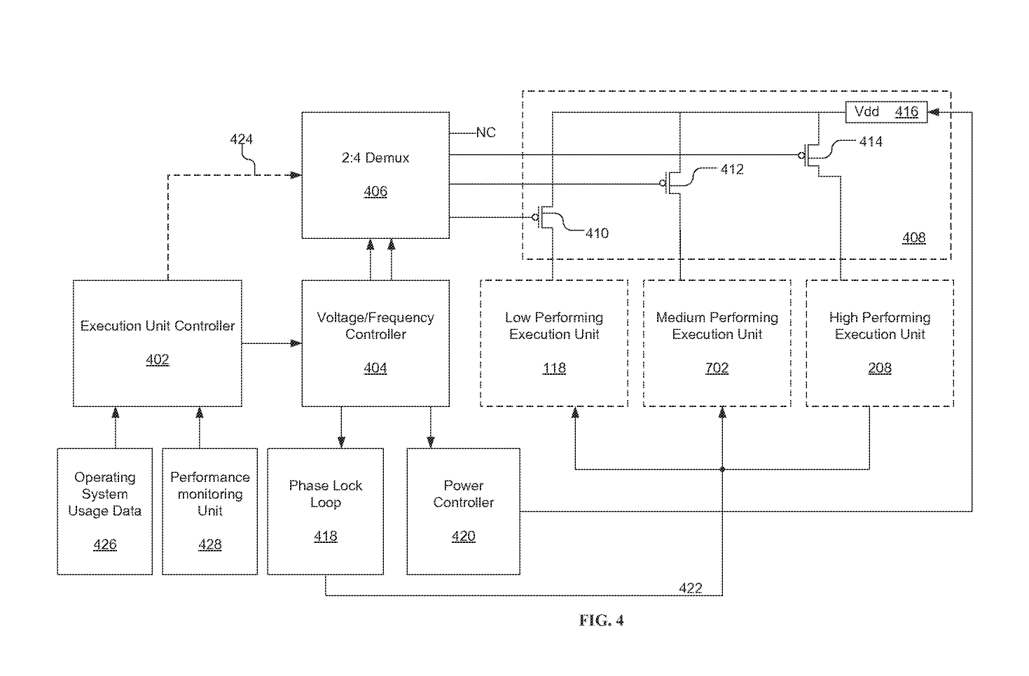

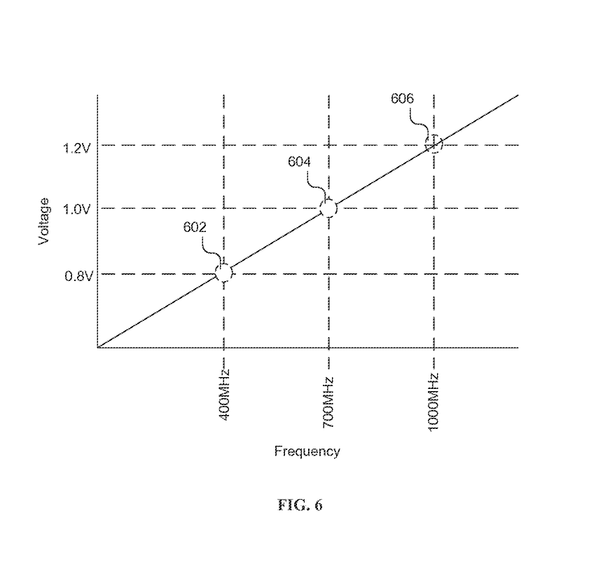

FIG. 4 shows the necessary functional blocks according to an embodiment. The execution unit controller 402 is used to check the utilization status of the system to determine the performance class of the execution units and invoke the voltage frequency controller to set the appropriate operating point shown in FIG. 6. The execution unit controller 402 may be realized in software where it would monitor usage statistics that are provided by the operating system 426 or in hardware where it could employ the use of a performance monitoring unit 428 that checks against the instruction throughput. In either case the execution unit controller 402 may read the CPU utilization percentage to determine the appropriate DVFS operating point like shown in FIG. 6 and enable the appropriate execution unit 118, 702 or 208 as shown in FIG. 4. It monitors the utilization levels of the system and determines when to toggle between voltage and frequency operating points such as 602, 604 and 606 via the voltage frequency controller 404 and enable execution units 118, 702, and 208 via switches 410, 412 and 414 respectively. The voltage frequency controller 404 may also be implemented in hardware or as a software. The voltage frequency controller 404 gets invoked by the execution unit controller 402 to change operating points 602, 604, and 606 by programming the phase lock loop 418 and the power manager to output the appropriate clock frequency signal 422 and voltage signal 416 which should be tailored to meet the timing constraints of each execution unit implementation.

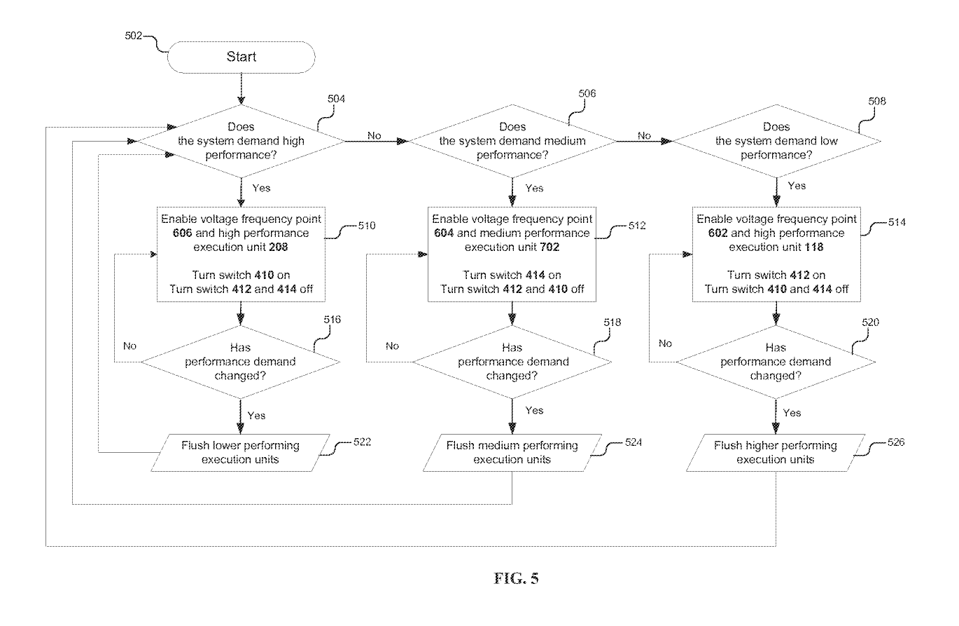

The execution unit controller 402 may use a control algorithm like the one shown in FIG. 5. In the case where the execution unit controller 402 detects a high performance demand from input sources 426 and 428, it will enable voltage and frequency point 606 by invoking the voltage frequency controller 404 to change the core voltage 416 and clock frequency 422 by programming the power manager 420 and the phase lock loop 418 as shown in step 510. The execution unit controller 402 continuously checks the performance demand of the system for changes as shown in steps 516, 518, and 520. If a change is detected the controller will flush registers or pipelines of the running execution units as shown in steps 522, 524, or 526, and then begin the process of checking the performance demand shown in steps 504, 506, or 508 to assign the appropriate DVFS operating point 602, 604, or 606 and corresponding execution unit 118, 702, or 208.

The programmable power controller unit 420 controls the core voltage level via power rail 416 whereas the programmable phase lock loop 418 drives the clock signal to all execution units via signal 422.

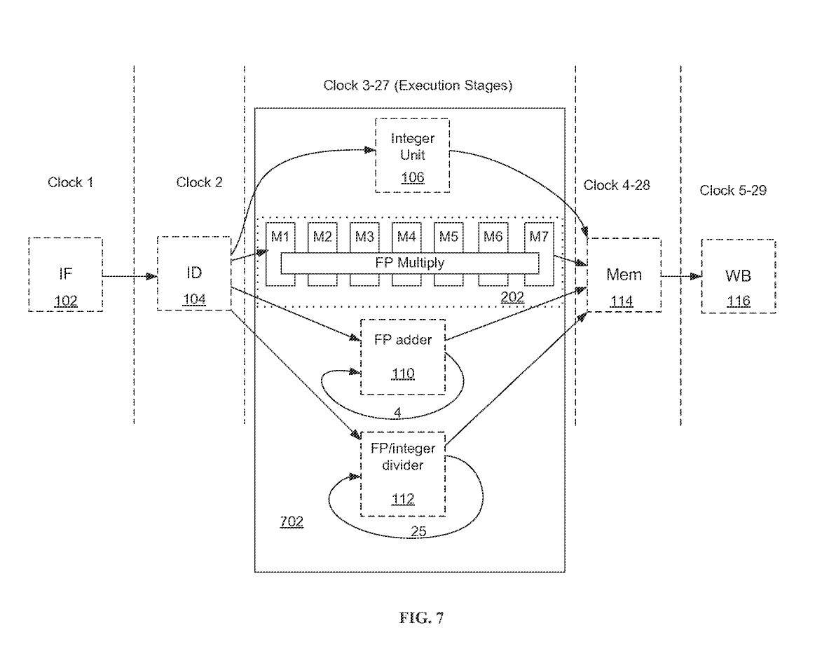

In the case where high performance execution units are not needed then the execution unit controller 402 will determine if the system requires the use of a medium performance class execution 702 unit which may be composed of pipelined and non-pipelined functional units like the unit shown in FIG. 7. In this scenario the execution unit controller 402 will enable the medium performance execution unit 702 by invoking the voltage frequency controller 404 to program the power controller 420 and phase lock loop 418 to the voltage and frequency values of operating point 604. The voltage frequency controller 404 enables the medium performance unit 702 by setting the appropriate bits to the 2:4 de-multiplexor 406 to enable power switch 412. If the execution unit controller 402 determines that the system doesn't require the use of higher and medium performing execution units it will invoke the voltage frequency controller 404 to enable the voltage frequency point 602 with the power controller 420 and phase lock loop 418. It will then enable the lower performing execution unit 118 by enabling switch 410 via enabling the appropriate bits to de-multiplexor 406.

The use of the de-multiplexor ensures that power is a mutually exclusive resource to execution units 118, 702 and 208 so that only one execution unit may be enabled at one time.

The implementation shown in this example introduces the use of three classes of execution units however more than three classes may be beneficial in an implementation depending on the application domain of the microprocessor. Additionally, the configuration of FIG. 7 shows a mix of pipelined and non-pipelined units as the definition of a medium class performance unit, however a medium performing execution unit may be realized with a lower number of pipeline stages and on a power optimized semiconductor process technology or a different mix of non-pipelined and pipelined functional units.

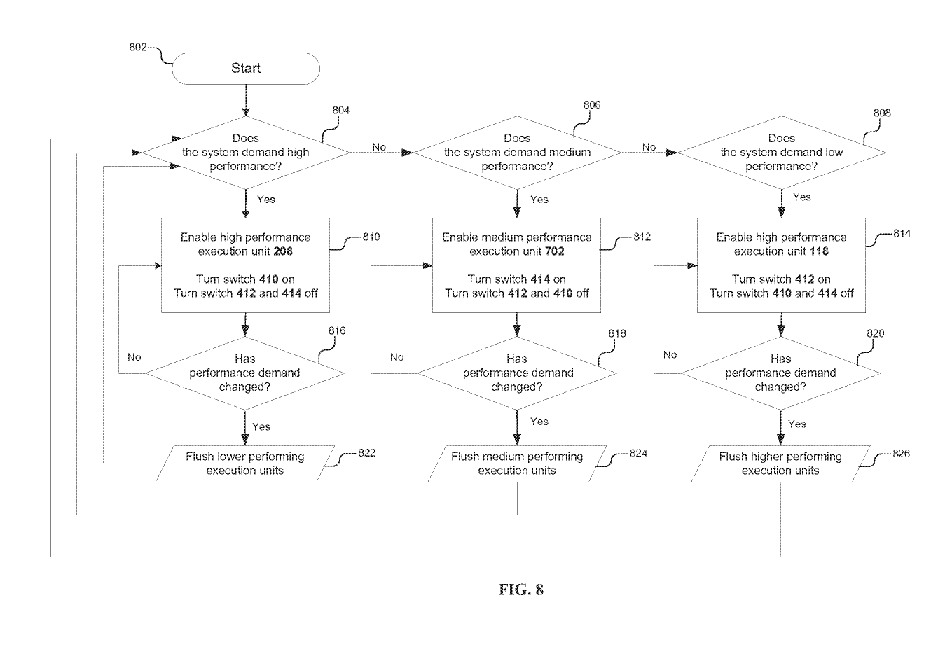

The invention disclosure also includes an embodiment described in FIG. 8 where dynamic voltage frequency scaling is not needed to swap execution units in order to save power. In this scenario the execution unit controller 402 will directly program the 2:4 de-multiplexor unit 406 via signal bus 424 to change the execution units to either one of 118, 702, or 208. This scenario could reduce the power consumption of a processor implementation because the number of transistors in the medium and lower performing execution units may be reduced in the case of a non-pipelined execution unit. However, with this scenario timing constraints must be considered so that the lower and medium performing execution units 118 and 702 do not introduce a critical path with regard to signal latency. With this embodiment, the FUs within the execution unit must be tailored to meet timing constraints for operating points such as shown in FIG. 6

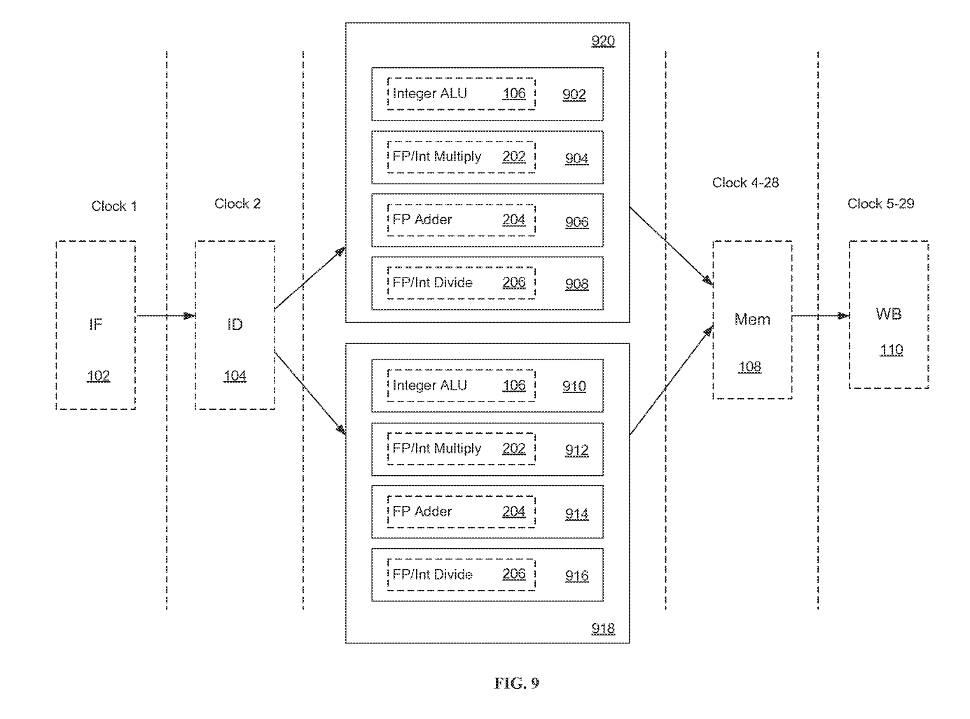

Additionally, this concept could be expanded to incorporate an auxiliary execution unit as shown in FIG. 9 that may be coupled and decoupled to the main execution unit such as 208. The auxiliary unit could be configured to be enabled when the main execution unit requires more processing power. The embodiment shown in FIG. 9 described a main execution unit 920 and an auxiliary execution unit 918 that may be enabled or power gated using a similar hardware implementation of FIG. 4 that allows for more than one execution unit to be powered at one time. The auxiliary execution unit 918 may be realized with an identical configuration as the main execution unit 920 to double the number of “like” FUs that are available to process instructions.

When the main execution unit requires more processing power, then execution unit 918 may be enabled via providing power to the unit. At this point the hardware in the instruction decode stage may issue instructions to the auxiliary execution unit 918 to increase instruction level parallelism and overall instruction throughput.

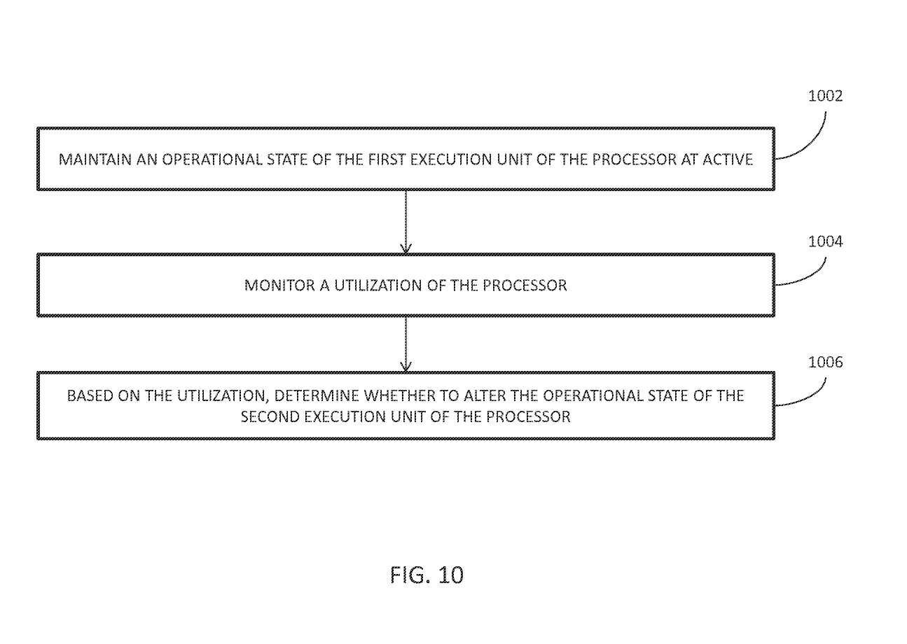

FIG. 10 is a process flow for controlling performance of a processor, according to an embodiment. In operation 1002, the system maintains an operational state of the first execution unit of the processor at active (e.g., enabled). In operation 1004, the system monitors a utilization of the processor. In operation 1006, the system, based on the utilization, determines whether to alter the operational state of the second execution unit of the processor.

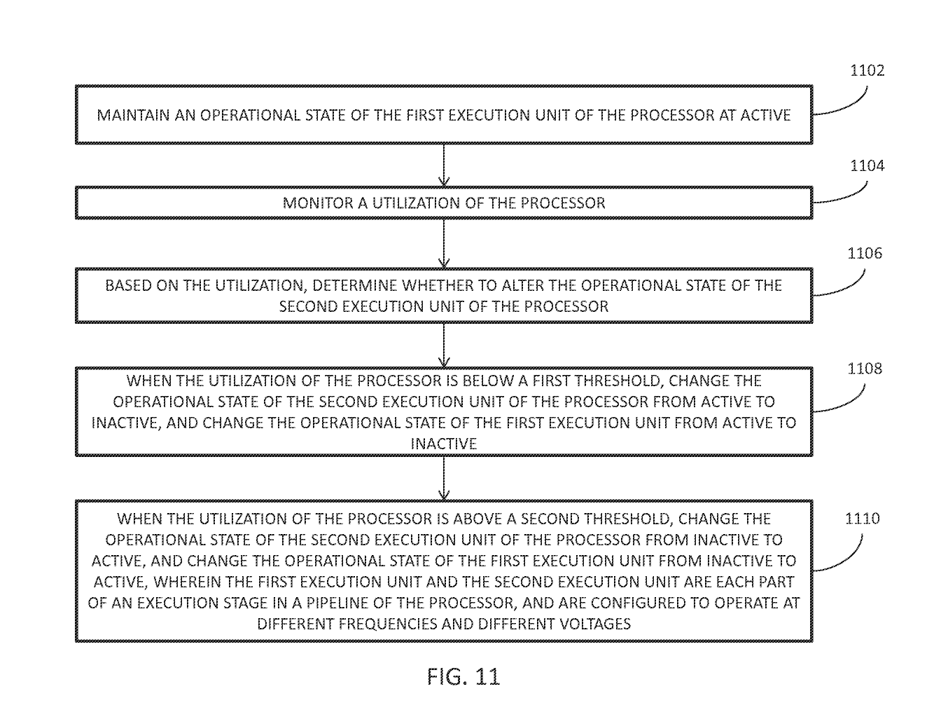

FIG. 11 is a process flow for controlling performance of a processor, according to another embodiment. In operation 1102, the system maintains an operational state of the first execution unit of the processor at active (e.g., enabled). In operation 1104, the system monitors a utilization of the processor. In operation 1106, based on the utilization, the system determines whether to alter the operational state of the second execution unit of the processor.

The first execution unit may be one of the low performing execution unit 118, the medium performing execution unit 702, the high performing execution unit 208, the main execution unit 920, and the auxiliary execution unit 918. The second execution unit may be a remaining one of the low performing execution unit 118, the medium performing execution unit 702, the high performing execution unit 208, the main execution unit 920, and the auxiliary execution unit 918.

When the utilization of the processor is below a first threshold, the system changes the operational state of the second execution unit of the processor from active to inactive, and changes the operational state of the first execution unit from active to inactive (e.g., disabled or power gated). When the utilization of the processor is above a second threshold, the system changes the operational state of the second execution unit of the processor from inactive to active, and changes the operational state of the first execution unit from inactive to active. The first execution unit and the second execution unit are each part of an execution stage in a pipeline of the processor, and are configured to operate at different frequencies and different voltages.

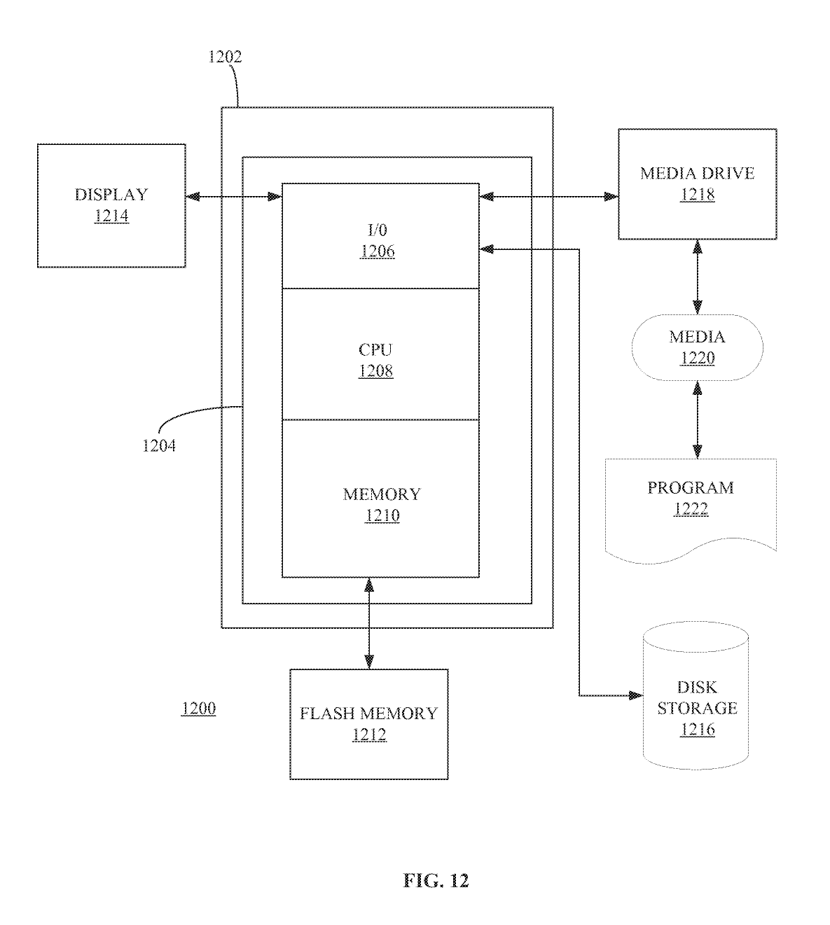

FIG. 12 depicts an exemplary computing system 1200 that can be configured to perform any one of the processes provided herein. In this context, computing system 1200 may include, for example, a processor, memory, storage, and I/O devices (e.g., monitor, keyboard, disk drive, Internet connection, etc.). However, computing system 1200 may include circuitry or other specialized hardware for carrying out some or all aspects of the processes. In some operational settings, computing system 1200 may be configured as a system that includes one or more units, each of which is configured to carry out some aspects of the processes either in software, hardware, or some combination thereof.

FIG. 12 depicts computing system 1200 with a number of components that may be used to perform any of the processes described herein. The main system 1202 includes a motherboard 1204 having an I/O section 1206, one or more central processing units (CPU) 1208 (e.g., a processor, an additional processor), and a memory section 1210, which may have a flash memory card 1212 related to it. The I/O section 1206 can be connected to a display 1214, a keyboard and/or other user input (not shown), a disk storage unit 1216, and a media drive unit 1218. The media drive unit 1218 can read/write a computer-readable medium 1220, which can contain programs 1222 and/or data. Computing system 1200 can include a web browser. Moreover, it is noted that computing system 1200 can be configured to include additional systems in order to fulfill various functionalities.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) or some specialized application-specific language (PHP, Java Script).

In an embodiment, a method of controlling performance of a processor having a first execution unit and a second execution unit includes maintaining an operational state of the first execution unit of the processor at active, monitoring a utilization of the processor, and based on the utilization, determining whether to alter the operational state of the second execution unit of the processor. The first execution unit and the second execution unit may have the same or different performance capabilities.

The method may include, when the utilization of the processor is below a first threshold and the performance capability of the second execution unit is less than the performance capability of the first execution unit, changing the operational state of the second execution unit of the processor from inactive to active, and changing the operational state of the first execution unit from active to inactive (e.g., enabled to power gated). The first threshold may be a particular percentage, such as 30%, 50%, or 70% of the processor capability. The method may include, when the utilization of the processor is above a second threshold and the performance capability of the second execution unit is greater than the performance capability of the first execution unit, changing the operational state of the second execution unit of the processor from inactive to active (e.g., power gated to enabled), and changing the operational state of the first execution unit from active to inactive. The second threshold may be a percentage that is greater than the first percentage, such as 80%, 90%, or 95%.

The first execution unit and the second execution unit may each be part of an execution stage in a pipeline of the processor. The first execution unit and the second execution unit may be configured to operate at different frequencies. The first execution unit and the second execution unit may be configured to operate at different voltages.

The processor may include at least three execution units capable of operating during the execution stage of the processor's pipeline, each of the three execution units having a distinct performance capability. The first execution unit and the second execution unit may have different quantities of at least one of pipelined functional units, non-pipelined functional units, and pipelined stages. Utilization of the processor may be monitored using software operating on an additional processor, or a performance monitoring unit comprising hardware configured to check instruction throughput.

When the processor task is to be transferred to the second execution unit, the system may alter a clock frequency of the processor execution stage using a phase locked loop.

When the utilization of the processor is below a first threshold, the system may change the operational state of the second execution unit of the processor from active to inactive (e.g., enabled to power gated) while maintaining the operational state of the first execution unit at active (e.g., enabled). When the utilization of the processor is above a second threshold, the system may change the operational state of the second execution unit of the processor from inactive to active while maintaining the operational state of the first execution unit at active.

In an embodiment, a system for controlling performance of a processor that includes a first execution unit and a second execution unit includes an execution unit controller. The execution unit controller is configured to maintain an operational state of the first execution unit of the processor at active, to monitor a utilization of the processor, and based on the utilization, to determine whether to alter the operational state of the second execution unit of the processor.

The first execution unit and the second execution unit may have the same or different performance capabilities. The execution unit controller may be configured, when the utilization of the processor is below a first threshold and the performance capability of the second execution unit is less than the performance capability of the first execution unit, to change the operational state of the second execution unit of the processor from inactive to active, and to change the operational state of the first execution unit from active to inactive.

In an embodiment, a method of controlling performance of a processor having a first execution unit and a second execution unit includes maintaining an operational state of the first execution unit of the processor at active. The method also includes monitoring a utilization of the processor, and based on the utilization, determining whether to alter the operational state of the second execution unit of the processor.

When the utilization of the processor is below a first threshold and the performance capability of the second execution unit is less than the performance capability of the first execution unit, changing the operational state of the second execution unit of the processor from active to inactive, and changing the operational state of the first execution unit from active to inactive.

When the utilization of the processor is above a second threshold and the performance capability of the second execution unit is greater than the performance capability of the first execution unit, changing the operational state of the second execution unit of the processor from inactive to active. The first execution unit and the second execution unit are each part of an execution stage in a pipeline of the processor, and are configured to operate at different frequencies and different voltages.

In the embodiment, the first execution unit and the second execution unit are each part of an execution stage in a pipeline of the processor, and are configured to operate at different frequencies and different voltages.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A method of controlling performance of a processor having a first execution unit and a second execution unit, the method comprising:
maintaining an operational state of the first execution unit of the processor at active;
monitoring a utilization of the processor; and
based on the utilization, determining whether to alter the operational state of the second execution unit of the processor.

2. The method of claim 1, wherein the first execution unit and the second execution unit have different performance capabilities.

3. The method of claim 1, wherein the first execution unit and the second execution unit have the same performance capabilities.

4. The method of claim 1, further comprising:
when the utilization of the processor is below a first threshold, changing the operational state of the second execution unit of the processor from inactive to active; and
changing the operational state of the first execution unit from active to inactive.

5. The method of claim 1, further comprising:
when the utilization of the processor is above a second threshold, changing the operational state of the second execution unit of the processor from inactive to active; and
changing the operational state of the first execution unit from active to inactive.

6. The method of claim 1, wherein the first execution unit and the second execution unit are each part of an execution stage in a pipeline of the processor.

7. The method of claim 1, wherein the first execution unit and the second execution unit are configured to operate at different frequencies.

8. The method of claim 1, wherein the first execution unit and the second execution unit are configured to operate at different voltages.

9. The method of claim 1, wherein the processor includes at least three execution units capable of operating during the execution stage of the processor's pipeline, each of the three execution units having a distinct performance capability.

10. The method of claim 1, wherein the first execution unit and the second execution unit have different quantities of at least one of pipelined functional units, non-pipelined functional units, and pipelined stages.

11. The method of claim 1, wherein utilization of the processor is monitored using software operating on an additional processor.

12. The method of claim 1, wherein utilization of the processor is monitored using a performance monitoring unit comprising hardware configured to check instruction throughput.

13. The method of claim 1, further comprising:
when the processor task is to be transferred to the second execution unit, altering a clock frequency of the processor execution stage using a phase locked loop.

14. The method of claim 1, further comprising:
when the utilization of the processor is below a first threshold, changing the operational state of the second execution unit of the processor from active to inactive while maintaining the operational state of the first execution unit at active.

15. The method of claim 1, further comprising:
when the utilization of the processor is above a second threshold, changing the operational state of the second execution unit of the processor from inactive to active while maintaining the operational state of the first execution unit at active.

16. A system for controlling performance of a processor that includes a first execution unit and a second execution unit, the system comprising:
an execution unit controller configured to maintain an operational state of the first execution unit of the processor at active, to monitor a utilization of the processor, and based on the utilization, to determine whether to alter the operational state of the second execution unit of the processor.

17. The system of claim 16, wherein the first execution unit and the second execution unit have different performance capabilities.

18. The system of claim 16, wherein the first execution unit and the second execution unit have the same performance capabilities.

19. The system of claim 16, wherein the execution unit controller is further configured, when the utilization of the processor is below a first threshold, to change the operational state of the second execution unit of the processor from active to inactive, and to change the operational state of the first execution unit from active to inactive.

20. A method of controlling performance of a processor having a first execution unit and a second execution unit, the method comprising:
maintaining an operational state of the first execution unit of the processor at active;
monitoring a utilization of the processor;
based on the utilization, determining whether to alter the operational state of the second execution unit of the processor;
when the utilization of the processor is below a first threshold, changing the operational state of the second execution unit of the processor from inactive to active, and changing the operational state of the first execution unit from active to inactive; and
when the utilization of the processor is above a second threshold, changing the operational state of the second execution unit of the processor from inactive to active, and changing the operational state of the first execution unit from active to inactive,
wherein the first execution unit and the second execution unit are each part of an execution stage in a pipeline of the processor, and are configured to operate at different frequencies and different voltages.
